(19) United States
(12) Patent Application Publication
(10) Pub. No.: US 2008/0286569 A1
(43) Pub. Date: Nov. 20, 2008

(54) Double-Sided Adhesive Having Light-Absorbing Properties for Producing and/or Gluing Lc-Displays

(75) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/915,252

(22) PCT Filed: Dec. 2, 2005
(86) PCT No.: PCT/EP05/56404

§ 371 Date: Mar. 25, 2008

(30) Foreign Application Priority Data
Jun. 13, 2005 (DE) 10 2005 027 350.5

(51) Int. Cl. B32B 33/00; B32B 37/12

(52) U.S. Cl. 428/337; 428/354; 428/332; 156/60

(57) ABSTRACT

An adhesive strip or tape for producing or gluing optical liquid crystal data displays (LCD's) is disclosed. The adhesive tape comprises an upper side and a lower side; a carrier film having an upper side and a lower side, wherein a laminate made from a dye-free adhesive layer and a colored adhesive layer applied to one side of the carrier film; and at least one external adhesive layer applied on the upper and lower sides of the adhesive tape.

The invention relates to double-sided pressure-sensitive adhesive tapes having multilayer constructions and having light-absorbing properties, for producing or for adhesively bonding liquid-crystal displays (LC displays, LCDs).

In the age of industrialization, pressure-sensitive adhesive (PSA) tapes are widespread processing auxiliaries. For use in the computer industry in particular, very exacting requirements are imposed on PSA tapes. As well as having a low outgassing behavior, the PSA tapes ought to be suitable for use across a wide temperature range and ought to fulfill defined optical properties.

One field of use is that of optical liquid-crystal displays (LC displays, LCDs), which are needed for computers, TVs, laptops, PDAs, cell phones, digital cameras, etc.

In this segment, it is very common around LC displays to use spacer tapes, which possess light-absorbing functions. The intention on the one hand is to prevent light from outside entering the display. On the other hand the intention is that no light should reach the outside from the light source of the LC display.

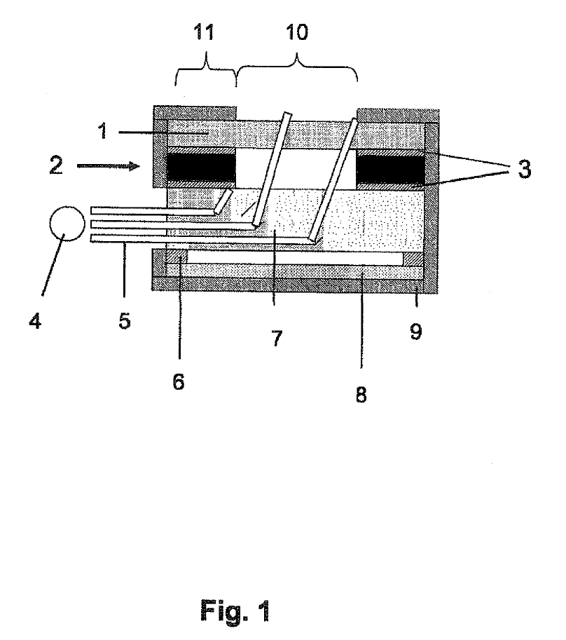

FIG. 1 shows schematically the principle of a double-sided black adhesive tape for light absorption, having the following meanings:

| | |
|---|---|
| 1 | LCD glass |
| 2 | double-sided black adhesive tape |
| 3 | pressure-sensitive adhesive |
| 4 | light source (LED) |
| 5 | light beams |
| 6 | double-sided adhesive tape |
| 7 | optical waveguide |
| 8 | reflector film |
| 9 | LCD housing |
| 10 | visible region |
| 11 | “blind” region |

Within this industry there is currently a trend toward more lightweight devices featuring higher resolution, and toward ever-larger LC displays. Associated with this trend, too, are stronger and increasingly more efficient light sources, which in turn are imposing more exacting requirements on the light-absorbing properties of the adhesive tape.

For this application it is common to employ black double-sided adhesive tapes. For the production of these adhesive tapes and for the carriers and pressure-sensitive adhesive systems they require there are numerous approaches in existence.

One approach to producing black double-sided PSA tapes lies in the coloring of the carrier material. Within the electronics industry it is very much preferred to use double-sided PSA tapes having PET carriers, since these carriers can be diecut very effectively. The PET carriers are colored with carbon black or black color pigments in order to achieve absorption of the light. Such systems are commercially available under, for example, Tesa™ 51965.

The drawback of this existing approach is the low level of light absorption. In very thin carrier layers, in particular in the case of very thin films, for example those having a thickness of 12 μm, only a relatively small number of carbon black particles or other black pigment particles can be incorporated, with the consequence that light absorption is incomplete. With the eye and also with relatively intense light sources (light intensity greater than 600 candelas), the deficient absorption can then be easily ascertained.

A further approach to producing black double-sided PSA tapes concerns the production of a two-layer or three-layer carrier material by means of coextrusion. Carrier films are conventionally produced by extrusion. By means of coextrusion, as well as the conventional carrier material, a second and also, optionally, a third black layer is or are coextruded, fulfilling the function of light absorption. This approach too has a variety of drawbacks. For example, antiblocking agents must be used for the extrusion and these then lead to what are called pinholes in the product. These pinholes are optical imperfections (light passage through these holes) and have a negative influence on the operation in the LCD.

A further problem is posed by the layer thicknesses, since the two or three layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise complete absorption cannot be realized. A further drawback lies in the altered mechanical properties of the carrier material, since at least one black layer is coextruded whose mechanical properties are different from those of the original carrier material (e.g., PET). A further drawback for the two-layer version of the carrier material is the difference in anchoring of the adhesive on the coextruded carrier material. For this embodiment there is always a weak point in the double-sided adhesive tape.

In a further approach a black paint layer is coated onto the carrier material, on one or both sides. This approach as well has a variety of drawbacks. On the one hand, here again, defects (pinholes) come about very easily, being introduced by antiblocking agents during the film extrusion operation, and cannot be painted over. These defects are unacceptable for the final application in the LC display. Furthermore, the maximum absorption properties do not correspond to the requirements, since only relatively thin paint layers are applied. Here again there is an upper limit to the layer thicknesses, since otherwise the mechanical properties of the carrier material would be altered.

There is a trend developing in the development of LC displays. On the one hand, the LC displays are to be lighter and also flatter, and there is a sharply rising demand for ever larger displays with ever greater resolution.

For this reason the design of the displays has been changed, and the light source is coming increasingly closer to the LCD panel, with the consequence of an increase in the risk of increasing quantities of light penetrating from the outside into the marginal zone of the LCD panel (“blind area”) (cf. FIG. 1). Along with this development there is also an increase in the requirements imposed on the blackout properties of the double-sided adhesive tape, and there is therefore a need for new approaches to the production of black adhesive tapes.

Listed below are a number of further publications relating to the prior art.

JP 2002-350612 describes double-sided adhesive tapes for LCD panels with light-protective properties. The function is achieved by means of a metal layer applied on one or both sides to the carrier film, it also being possible, additionally, for the carrier film to have been colored. However, this invention only attempts to compensate for the cause of the pinholes by the double-sided metallization of the carrier films. Freedom from pinholes is not achieved using this approach.

JP 2002-023663 likewise describes double-sided adhesive tapes for LCD panels that have light-protective properties. Here again, the function is achieved by means of a metal layer applied on one or both sides to the carrier film. The patent additionally embraces colored adhesives. In analogy to JP 2002-350612, this invention, again, attempts only to compensate the cause of the pinholes by double-sided metallization of the carrier films. Furthermore, the pressure-sensitive adhesives colored black using carbon black cause irreversible residues on the substrate. Moreover, there are significant changes in the adhesive properties of the pressure-sensitive adhesive systems. The compounding of the pressure-sensitive adhesive system with carbon black, typically in a concentration range of 3%-25% by weight, results in a significant change to the cohesion-determined and adhesion-determined values. For example, the moisture resistance of an acrylate PSA system is significantly impaired as a result of admixing carbon black.

For the adhesive bonding of LCD displays and for their production, therefore, there is furthermore a need for double-sided PSA tapes which do not have the deficiencies described above, or which have them only to a reduced extent.

It is an object of the invention to provide a double-sided PSA tape which avoids pinholes in the application, and possesses a pressure-sensitive adhesive which by virtue of its fillers does not exhibit any change in technical adhesive performance properties, the tape additionally being capable of completely absorbing light.

This object is achieved by means of a pressure-sensitive adhesive tape as described in the main claim. In the context of this invention it has surprisingly been found that two pressure-sensitive adhesive layers can be laminated together, one pressure-sensitive adhesive layer having been provided with fillers, such as carbon black, for example, and the second pressure-sensitive adhesive layer being filler-free. Unexpectedly, in spite of the fillers in the one layer, there is a firm bond between filled and filler-free layers. Through the use of the filler-free pressure-sensitive adhesive layer as the outer ply, it is ensured that no deleterious discolorations can arise in the bond substrate. The pressure-sensitive adhesive layer filled with filler, such as carbon black, for example, is used as the inner layer.

Furthermore, this also ensures that the outer layer, which is the adhesively active layer, is filler-free. There is no deleterious change in the adhesion or in the cohesion of the pressure-sensitive adhesive layer, and the resulting properties such as bond strength or shear strength are retained.

The dependent claims relate to advantageous embodiments of the invention, and also to the use of the PSA tape according to the invention.

The main claim accordingly provides a pressure-sensitive adhesive tape, in particular for the production or adhesive bonding of optical liquid-crystal displays (LCDs), comprising a top side and a bottom side, further comprising a carrier film having a top side and a bottom side, the pressure-sensitive adhesive tape being furnished both on its top side and on its bottom side with at least one external pressure-sensitive adhesive layer in each case, wherein additionally provided at least on one side of the film is a laminate of a dye-free and a colored PSA layer.

The dye-free PSA layer is very preferably transparent. Preference is further given to a version of the pressure-sensitive adhesive tape in which the colored PSA layer is black.

In one very preferred embodiment of the invention the colored PSA layer is provided between the carrier film and the dye-pure PSA layer. It is very advantageous if the dye-free PSA layer is the outer PSA layer on the pressure-sensitive adhesive tape side.

In one preferred embodiment of the pressure-sensitive adhesive tape of the invention there is a corresponding laminate provided on both sides of the carrier film, it being possible for the laminates to be identical or different (in respect, for example, of the layer sequence, the layer thicknesses of the PSAs, the additives in the PSAs, and/or the chemical composition of the PSAs, to name but a few).

It can be advantageous to make both outer PSAs transparent.

A product advantage of the layer construction in comparison to simple painted films lies in the viscoelastic matrix structure of the pressure-sensitive adhesive layers. Films equipped with a thin and therefore highly filled (with carbon black, for example), black-colored paint layer are of low elasticity, owing of the high degree of filling. Moreover, the highly filled paint layer is very fragile and therefore tends toward cracks when the adhesive tape is under extreme mechanical stress. In contrast, the introduction of a filler, such as carbon black, for example, into a thick pressure-sensitive adhesive layer does not result in any deleterious change to the viscoelastic behavior or, therefore, to the adhesive properties.

Set out below are some advantageous embodiments of the pressure-sensitive adhesive tape of the invention, without wishing the choice of the examples to impose any unnecessary restriction.

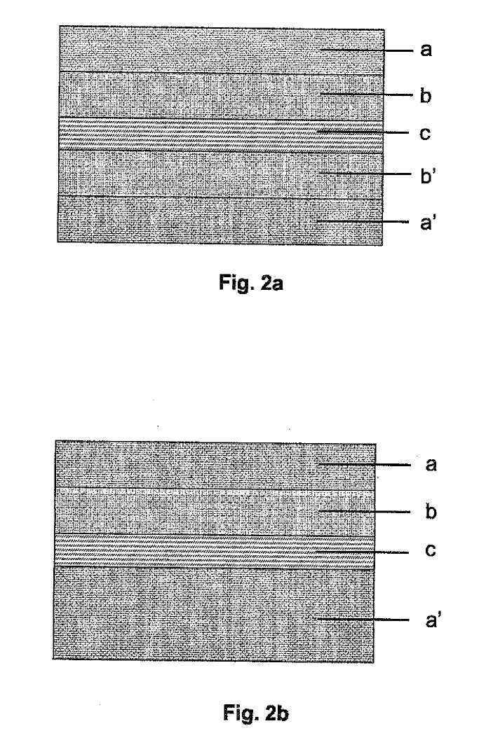

In a first preferred implementation, as depicted in FIG. 2a, the inventive pressure-sensitive adhesive tape is composed of a polymeric carrier film (c) covered on both sides with a two-layer pressure-sensitive adhesive. The chromophoric pressure-sensitive adhesive layers (b) and (b′) which border on the polymeric carrier film (c) are each equipped with filler (carbon black). The two outer pressure-sensitive adhesive layers (a) and (a′) are preferably dye-free, being more particularly transparent or semitransparent, and contain no fillers.

The polymeric carrier film (a) is preferably between 5 and 250 μm, more preferably between 8 and 50 μm, most preferably between 12 and 36 μm thick and is transparent or semitransparent or of low light transmittance as a result, for example, of coloring with pigments such as carbon black.

In one specific embodiment the carrier film may also, additionally, have been vapor-coated on one or both sides with metal, aluminum or silver for example. The layer thickness of the metallic layers is preferably between 5 nm and 200 nm.

The total thickness of the PSA layers (a+b) and (a′+b′) is preferably not more than 140 μm in each case. The filler-free layers (a) and (a′) may have a thickness of 5-135 μm. Both layers may have an identical or different layer thickness. The filler-containing layers (b) and (b′) may have a thickness of 5-135 μm. Both layers may have an identical or different layer thickness.

The pressure-sensitive adhesive layers (a) and (a′) and also (b) and (b′) may be constructed from identical or different PSAs.

In a further advantageous embodiment (cf. in this regard FIG. 2b) the inventive pressure-sensitive adhesive tape is likewise composed of a polymeric carrier film (c), but of only one bordering chromophoric pressure-sensitive adhesive layer (b) equipped with carbon black. The two outer pressure-sensitive adhesive layers (a) and (a′) are again preferably dye-free, being more particularly transparent or semitransparent, and contain no fillers.

### Carrier Film (c)

As film carriers it is possible in principle to use all film-type polymer carriers, more particularly those which are transparent. Thus, for example, polyethylene, polypropylene, polyimide, polyester, polyamide, polymethacrylate, fluorinated polymer films, etc., can be used. One particularly preferred embodiment uses polyester films, with particular preference PET (polyethylene terephthalate) films. The films may be present in detensioned form or may have one or more preferential directions. Preferential directions are achieved by stretching in one or two directions. Usually, antiblocking agents, such as, for example, silicon dioxide, siliceous chalk or chalk, or zeolites are used for the production process for films, such as, for example, PET films.

PET films 12 μm thick and thinner films can be used particularly well according to the invention because they allow very good technical properties for the double-sided adhesive tape. The film is very flexible and is able to conform well to the surface roughnesses of the substrates that are to be bonded.

To improve the anchoring of the pigment-filled PSA layers or of the metal vaporization it is very advantageous if the films are pretreated. The films may be etched (using trichloroacetic or trifluoroacetic acid, for example), corona- or plasma-pretreated, or furnished with a primer (e.g., Saran).

Furthermore, it is also possible with advantage, especially if the film material is transparent or semitransparent, to add color pigments or chromophoric particles to the film material. Hence, for example, carbon black is suitable for black coloring, and titanium dioxide particles for white coloring. The pigments or particles ought preferably, however, to be smaller in diameter than the final layer thickness of the carrier film. Optimum colorations can be achieved with 5% to 40% by weight particle fractions based on the film material.

Filler-Containing PSAs (b) and (b′)

For the production of the light-absorbing pressure-sensitive adhesive layer the PSAs (b) and (b′) are blended with carbon black pigments. These pigments can be used in the form of a color paste.

Color pastes containing carbon black that can be used include, for example, Pritex 25® and Tack 101 T® from Degussa or Sicoflush L Schwarz 0063® from BASF. The carbon black fraction in the pressure-sensitive adhesive layer (b) or (b′) may be between 2% and 30% by weight, between 5% and 20% by weight in one more-preferred version, and between 8% and 15% by weight in one very preferred version.

Pressure-Sensitive Adhesive Laminates (PSA Laminates) (a)/(b) and (a′)/(b′)

The PSAs (a) and (b′) and (a′) and (b′) are, in one preferred embodiment, identical on both sides of the PSA tape. In one specific embodiment, however, it may also be of advantage for the PSA layers (a)/(b) and (a′)/(b′) to differ from one another, in terms of layer thickness and/or chemical composition. Hence in this way it is possible, for example, to set different pressure-sensitive adhesion properties. PSA systems used for the inventive double-sided PSA tape are acrylate, natural-rubber, synthetic-rubber, silicone or EVA adhesives.

It is possible, furthermore, to process the further PSAs that are known to the skilled worker as mentioned, for example, in the “Handbook of Pressure Sensitive Adhesive Technology” by Donatas Satas (van Nostrand, N.Y. 1989).

For natural-rubber adhesives the natural rubber is preferably milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is made of (meth)acrylate PSAs.

(Meth)acrylate PSAs employed in accordance with the invention, which are obtainable by free-radical addition polymerization, advantageously consist to the extent of at least 50% by weight of at least one acrylic monomer from the group of the compounds of the following general formula:

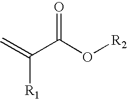

In this formula the radical R₁═H or CH₃ and the radical R₂═H or CH₃ or is selected from the group containing the branched and unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, N.Y. 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁═H or CH₃ and R₂ is an alkyl chain having 1-20 carbon atoms or is H.

The molar masses M_{w} (weight average) of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacryl-amide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, where this enumeration is not to be understood as exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, where this enumeration is not to be understood as exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in a further advantageous procedure, use is made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, where this enumeration is not to be understood as exhaustive.

As a result of the increase in the aromatic fraction there is a rise in the refractive index of the PSA.

For further development it is possible to admix resins to the PSAs. As tackifying resins for addition it is possible to use the tackifier resins previously known, and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989). Here as well, the transparency is improved using, preferably, transparent resins which are highly compatible with the polymer. Hydrogenated or partly hydrogenated resins frequently feature these properties.

In addition it is possible optionally to add plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers.

In a further advantageous embodiment of the invention the PSA of the layers (b) and/or (b′) comprises light-absorbing particles, such as black color pigments or carbon-black particles or graphite particles, for example, as a filler.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for the Acrylate PSAs

For the polymerization the monomers are advantageously chosen such that the resulting polymers can be used at room temperature or higher temperatures as PSAs, in particular such that the resulting polymers possess pressure-sensitive adhesive properties in accordance with the “Handbook of Pressure Sensitive Adhesive Technology” by Donatas Satas (van Nostrand, N.Y. 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with equation (E1) analogous to the Fox equation (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ the mass fraction of the respective monomer n (% by weight), and T_{g,n} the respective glass transition temperature of the homopolymer of the respective monomers n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azoisobutyronitrile (AIBN).

The weight-average molecular weights M_{w} of the PSAs formed in the free-radical polymerization are very preferably chosen such that they are situated within a range of 200 000 to 4 000 000 g/mol; specifically for further use as electrically conductive hotmelt PSAs with resilience, PSAs are prepared which have weight-average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group 1, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

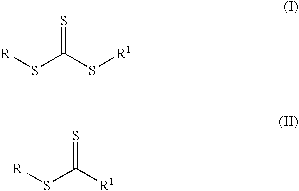

in which R and R¹ are chosen independently of one another or are identical, and
branched and unbranched C₁ to C₁₋₈ alkyl radicals; C₃ to C₁₈ alkenyl radicals; C₃ to C₁₈ alkynyl radicals;
C₁ to C₁₈ alkoxy radicals;

C₃ to C₁₈ alkynyl radicals; C₃ to C₁₈ alkenyl radicals; C₁ to C₁₋₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following compounds: halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl radicals having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

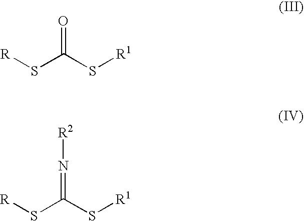

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

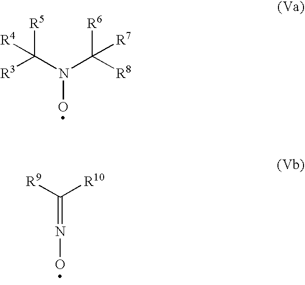

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs.

With greater preference, controlled regulators for the polymerization of compounds of the following types are used:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″ N—O—Y, in which Y is a free-radical species which is able to polymerize unsaturated monomers. In general, however, the reactions have low conversion rates. A particular problem is the polymerization of acrylates, which takes place only with very low yields and molar masses.

WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates.

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process

For preparation, in one preferred embodiment the pigment-filled pressure-sensitive adhesive is coated from solution onto the carrier material. The pigments have been stirred into the PSA beforehand using a high-speed stirrer. To improve the anchoring of the PSAs (b) and (b′) to the carrier film (c) it is possible optionally to pretreat them. Thus pretreatment may be carried out, for example, by corona or by plasma, a primer can be applied from the melt or from solution, or etching may take place chemically.

For the coating of the PSA from solution, heat is supplied, in a drying tunnel, for example, to remove the solvent and, where appropriate, initiate the crosslinking reaction. The pressure-sensitive adhesive layers (a) and (a′) may likewise be generated from solution. Carrier material employed encompasses anti-adhesively treated films and papers. Following removal of the solvent, these pressure-sensitive adhesive layers are laminated onto the filler-containing layers. This laminating operation may be assisted by pressure and temperature. Furthermore, the strength of lamination of the two layers of adhesive may be assisted by an upstream corona treatment. An alternative advantageous procedure is to coat the dried, filler-containing layers (b)/(b′) directly with the PSAs (a)/(a′).

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels.

Through the coating it is also possible for the PSAs to undergo orientation.

In addition it may be necessary for the PSA to be crosslinked. In one preferred version, crosslinking takes place with electron and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention the PSAs are crosslinked using electron beams. Typical irradiation equipment which can be advantageously employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 and 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for adhesive bonding or production of LC displays. For use as pressure-sensitive adhesive tape it is possible for the double-sided pressure-sensitive adhesive tapes to have been lined with one or two release films or release papers. In one preferred embodiment, use is made of siliconized or fluorinated films or papers, such as glassine, HDPE or LDPE coated papers, for example, which have in turn been given a release coat based on silicones or fluorinated polymers.

With particular advantage the PSA tapes of the invention are suitable for adhesively bonding light-emitting diodes (LEDs) as a light source with the LCD module.

### EXAMPLES

The invention is described below, without wishing any unnecessary restriction to result from the choice of the examples.

The following test methods were employed.

### Test Methods

### A. Transmittance

The transmittance was measured in the wavelength range from 190 to 900 nm using a Uvikon 923 from Biotek Kontron. The measurement is conducted at 230C. The absolute transmittance is reported as the value at 550 nm in % relative to complete light absorption (transmittance 0%=no light transmission; transmittance 100%=complete light transmission).

### B. Pinholes

A very strong commercial light source (e.g., an overhead projector of the Liesegangtrainer 400 KC type 649 type, 36 V halogen lamp, 400 W) is covered over with a mask so that absolutely no light escapes. This mask contains in its center a circular opening with a diameter of 5 cm. The double-sided adhesive LCD tape is placed onto this circular opening. In a completely darkened environment, the number of pinholes is then counted electronically or visually. When the light source is switched on, these pinholes can be seen as dots where light shines through.

### Polymer 1 (Unfilled)

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h 40 g of AIBN were again added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture was cooled to room temperature.

Polymer 2 (filled)

The polymer 1 is admixed with Printex 25® (Degussa) or Sicoflush L Schwarz 0063® (BASF). The amount of the color pastes is chosen such that the total carbon black fraction in the filled pressure-sensitive adhesive layer is 10% by weight. Using a high-speed stirrer, the carbon black pigments are distributed homogeneously in the PSA over a period of 45 minutes.

### Production of the Pressure-Sensitive Adhesive Layers

The PSAs are coated from solution onto a siliconized release film (75 μm PET film from Loparex) and dried in a drying cabinet at 100° C. for 10 minutes.

The PSA layers are then laminated together (temperature 60° C., pressure 20 N/cm²) and then crosslinked with a dose of 25 kGy of electron beams at an acceleration voltage of 200 kV. The coatweight of the individual layers can be found in Table 1.

TABLE 1
Table 1: Product overview

| | Example 1 | Example 2 | Example 3 | Example 4 |
|---|---|---|---|---|
| Unfilled | Polymer 1 | Polymer 1 | Polymer 1 | Polymer 1 |
| layer (a) | thickness 20 μm | thickness 6 μm | thickness 20 μm | thickness 10 μm |
| Filled layer | Polymer 2 | Polymer 2 | Polymer 2 | Polymer 2 |
| (b) | thickness 6 μm | thickness 20 μm | thickness 6 μm | thickness 50 μm |
| Filler systems: | Printex 25 ® | Printex 25 ® | Sicoflush L | Sicoflush L |
| | (Degussa) | (Degussa) | Schwarz 0063 ® | Schwarz 0063 ® |
| | | | (BASF) | (BASF) |
| Carrier film (c)* | PET 12 μm | PET 12 μm | PET 50 μm | PET 12 μm |
| Filled layer | Polymer 2 | Polymer 2 | Polymer 2 | none present |
| (b′) | thickness 6 μm | thickness 20 μm | thickness 6 μm | |
| Filler systems: | Printex 25 ® | Printex 25 ® | Sicoflush L | |
| | (Degussa) | (Degussa) | Schwarz 0063 ® | |
| | | | (BASF) | |
| Unfilled layer (a′) | Polymer 1 | Polymer 1 | Polymer 1 | Polymer 1 |
| | thickness: 20 μm | thickness 6 μm | thickness: 20 μm | thickness: 10 μm |

*12 μm PET film: Hostaphan RNK 12 μm ® (Mitsubishi Polyester Film)

### Results

Table 2 shows the test results of reference examples 1 to 4 in accordance with test methods A and B.

TABLE 2

| | Transmittance | Pinholes |
|---|---|---|
| Example | (Test A) | (Test B) |
| 1 | <0.1% | 0 |
| 2 | <0.1% | 0 |
| 3 | <0.1% | 0 |
| 4 | <0.1% | 0 |

The examples therefore demonstrate that with this multilayer product construction it is possible to reduce the number of pinholes to 0.

1. A pressure-sensitive adhesive tape for the production or adhesive bonding of optical liquid-crystal displays (LCDs), comprising a top side and a bottom side, a carrier film having a carrier film top side and a carrier film bottom side, and at least one external pressure-sensitive adhesive layer provided on both the top and bottom side of the adhesive tape, wherein one side of the film further comprises a laminate of a dye-free pressure sensitive adhesive layer and a colored pressure sensitive adhesive layer.

2. The pressure-sensitive adhesive tape of claim 1 wherein the dye-free pressure-sensitive adhesive layer is transparent.

3. The pressure-sensitive adhesive tape of claim 1 wherein the colored pressure-sensitive adhesive layer is black.

4. The pressure-sensitive adhesive tape of claim 1 wherein the colored pressure-sensitive adhesive layer is provided between the carrier film and the dye-free pressure-sensitive adhesive layer.

5. The pressure-sensitive adhesive tape of claim 1 wherein the dye-free pressure-sensitive adhesive layer is the outer pressure-sensitive adhesive layer on the pressure-sensitive adhesive tape side.

6. The pressure-sensitive adhesive of a claim 1 wherein a layer sequence is comprised as follows: transparent pressure-sensitive adhesive-colored pressure-sensitive adhesive-carrier film-transparent pressure-sensitive adhesive.

7. The pressure-sensitive adhesive tape of claim 6 wherein the layer sequence is comprises as follows: transparent pressure-sensitive adhesive-colored pressure-sensitive adhesive-carrier film-colored pressure-sensitive adhesive-transparent pressure-sensitive adhesive.

8. The pressure-sensitive adhesive tape of claim 1 wherein the carrier film has a thickness between 5 and 250 μm.

9. The pressure-sensitive adhesive tape of claim 1 wherein at least one laminate has a layer thickness of not more than 140 μm.

10. A method for producing or adhesively bonding optical liquid-crystal displays (LCDs) comprising providing a pressure sensitive adhesive tape according to claim 1 to an optical liquid-crystal display.

11. The method of claim 10 wherein LCD glasses are bonded.

12. A liquid-crystal display device comprising a pressure-sensitive adhesive tape of claim 1.

13. The pressure sensitive adhesive tape of claim 8 wherein the carrier film has a thickness between about 8 and 50 μm.

14. The pressure sensitive adhesive tape of claim 13 wherein the carrier film has a thickness of about 12 μm.

15. The pressure sensitive adhesive tape of claim 9 wherein the dye free layers have a thickness of between about 5-135 μm and the filler-containing layers have a thickness of between about 5-135 μm.
